(19) United States
(12) Patent Application Publication
(10) Pub. No.: US 2005/0279517 A1
(43) Pub. Date: Dec. 22, 2005

(54) Screw driving apparatus with attachable and detachable nose sub-assembly for use with single-feed screws or for use with automatic-feed collated screws

(76) Inventors: William Herschel Hoffman, Cincinnati, OH (US); Donald Joseph Massari JR., Cincinnati, OH (US); Michael Ryan Desmond, Newport, KY (US); Gary Michael Bohart, Cincinnati, OH (US)

Correspondence Address: Frederick H. Gribbell;FREDERICK H. GRIBBELL, LLC, Suite 120, 10250 Alliance Road, Cincinnati, OH, 45242, US

(21) Appl. No.: 11/106,227

(22) Filed: Apr. 14, 2005

Related U.S. Application Data
(60) Provisional application No. 60/581,540, filed on Jun. 21, 2004.

(51) Int. Cl. B25C 5/02

(52) U.S. Cl. 173/29; 227/136

(57) ABSTRACT

An improved hand-held screw driving tool is provided with a quick release nose sub-assembly, which can readily be attached to and detached from a main body of the tool. This capability allows the tool to be used in several different ways, by putting different nose sub-assemblies onto the main body of the tool. For example, one nose sub-assembly could drive a strip of collated screws, whereas a different nose sub-assembly could use single feed screws that are individually placed at a drive position of the nose sub-assembly. Another possible nose sub-assembly is a cutter or shears attachment that can be driven by the rotary motion of the tool's motor. Various sizes and types of fasteners can be driven by this tool.

### CROSS-REFERENCE TO RELATED APPLICATIONS

The present application claims priority to provisional patent application Ser. No. 60/581,540, titled “AUTO FEED/SINGLE FEED CORDLESS SCREW DRIVING TOOL WITH ELECTRONIC TORQUE CONTROL,” filed on Jun. 21, 2004.

### TECHNICAL FIELD

The present invention relates generally to hand-held fastener driving equipment and is particularly directed to an electrically powered portable fastener driver tool of the type which drives collated fasteners into solid objects. The invention is specifically disclosed as a fastener driving tool with a detachable nose sub-assembly, which allows the tool to be used in several different ways, by putting different nose sub-assemblies onto the main body of the tool. For example, one nose sub-assembly could drive a strip of collated screws, whereas a different nose sub-assembly could use single feed screws that are individually placed at a drive position of the nose sub-assembly. Another possible nose sub-assembly is a cutter or shears attachment that can be driven by the rotary motion of the tool's motor.

### BACKGROUND OF THE INVENTION

Hand-held fastener driving tools have been available for use with collated strips of fasteners, such as screws. Some conventional collated strip screw driving tools have a front or nose portion that is permanently attached to the main body of the tool, and this nose portion is pressed against a surface that the fastener will be driven into. The nose portion has an indexing mechanism to index the position of the collated strip to the next screw that will be driven. Such tools typically have a depth of drive user adjustment, to control how far the fastener or screw will be driven into the solid object by the tool.

Other types of conventional fastener driving tools use an attachment that is placed over a portable electrical tool, such as a drill or a screw driving tool, and this attachment allows the other portable tool to be used with a collated strip of screws (or other type of fasteners). The attachment includes a movable nose piece that is pressed against the solid surface, and typically would have some type of depth of drive user control.

Most conventional screw driving tools do not allow the user to quickly change from an automatic feed system that uses a strip of collated screws to manually feeding a single screw by hand. The conventional screw driving tools that have some type of torque control use a ball ratcheting torque clutch, which can be noisy by its design. The conventional screw driving tools that have an automatic feed system have difficulty removing a driven screw, since either (1) there is no reverse functionality at all, or (2) they involve a rather difficult process of removing the collated strip of screws from the tool, then aligning the nose of the tool over the driven screw and adjusting any depth settings (if they are included), and then finally reversing the screw from the solid object.

In the conventional self-contained screw driving tools, the entire nose portion is not easily detached from the main body of the tool, and an example of such a construction is disclosed in U.S. Pat. No. 5,988,026, co-assigned to Senco Products, Inc. of Cincinnati, Ohio. A detachable nose portion may have certain advantages, and a torque limiting control circuit could be used in place of a depth of drive control for such a configuration.

### SUMMARY OF THE INVENTION

Accordingly, it is an advantage of the present invention to provide a hand-held fastener driving tool that includes a detachable nose sub-assembly, in which various types of different nose sub-assemblies can be quickly and readily attached to and detached from the tool's main body.

It is another advantage of the present invention to provide a portable hand-held fastener driving tool that includes a user-adjustable torque limiting control.

It is a further advantage of the present invention to provide a hand-held fastener driving tool for use with various types of fasteners, including individually-fed fasteners that are placed at a driving position of a first type of nose sub-assembly, including a strip of collated fasteners that are loaded into a different type of nose sub-assembly, or a shears attachment that comprises yet another type of nose sub-assembly, or to leave the nose sub-assembly entirely off of the main body of the tool to expose the driving bit for various purposes, including removing screws that have already been driven into solid objects.

It is yet another advantage of the present invention to provide a portable hand-held fastener driving tool that includes a detachable nose sub-assembly, in which the nose sub-assembly may have a depth of drive control that is adjustable by a user, or if it has no such depth of drive control, it will instead rely on the tool's electronic torque limiting control device.

It is still another advantage of the present invention to provide a portable hand-held fastener driving tool that includes a detachable nose sub-assembly, in which some of the nose sub-assemblies have an “index on advance” mode of operation, while other nose sub-assemblies have an “index on return” mode of operation, in which the “lead screw” is moved into a “firing position” (or “driving position”) just as the tool begins a driving event, or just after the tool finishes a previous driving event of a fastener, respectively.

It is still a further advantage of the present invention to provide a hand-held fastener driving tool that includes a detachable nose sub-assembly, in which the nose attachment can remain off the tool's main body to expose the drive bit, which provides an improved line of sight to remove driven screws, or to drive a single hand-fed screw, and moreover when driving a screw with the feed system of a nose sub-assembly detached, this results in a smaller length tool for reaching into tighter spaces.

It is yet a further advantage of the present invention to provide a hand-held fastener driving tool for use with a shears attachment that can be used for cutting sheet metal, or for use with a nibbler attachment for nibbling sheet metal, or for use with some type of cutoff saw or a hole punching device, as the nose sub-assembly.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a hand-held fastener-driving tool is provided, which comprises: (a) a housing containing a prime mover device, and a first intermediate drive device that translates movement from the prime mover device toward an output end of the housing; (b) an attachable/detachable nose sub-assembly having an input end and a final drive end, wherein when the nose sub-assembly is mated to the housing, the input end is positioned proximal to the output end of the housing; the nose sub-assembly being configured to receive a collated strip of fasteners and to move a fastener of the collated strip of fasteners toward the final drive end; wherein: (i) the input end includes a second intermediate drive device that may be in communication with the first intermediate drive device when the housing is attached to the nose sub-assembly, and (ii) the final drive end of the nose sub-assembly includes a fastener driving mechanism that is used for driving the fastener into an object, the fastener driving mechanism being in communication with the second intermediate drive device; and (c) a quick release latching mechanism, wherein: (i) when the housing and the nose sub-assembly are brought together, the quick release latching mechanism becomes engaged to hold the housing and the nose sub-assembly together, such that the first and second intermediate drive devices may operate in communication with one another, and such that the fastener driving mechanism may be driven by the prime mover device through the first and second intermediate drive devices; and (ii) when disengaged, the quick release latching mechanism allows the nose sub-assembly to readily detach from the housing, wherein the first and second intermediate drive devices may separate without damage to one another.

In accordance with another aspect of the present invention, a hand-held fastener-driving tool is provided, which comprises: (a) a housing containing a prime mover device, the housing having a first end and a second end, the housing including a first intermediate drive device that translates movement from the prime mover device toward the second end; (b) a handle that is positioned proximal to the housing; (c) a hand-operated control device, and when the control device is actuated, the prime mover device may be engaged; (d) an attachable/detachable nose sub-assembly having a third end and a fourth end, wherein when the nose sub-assembly is mated to the housing, the third end is positioned proximal to the second end of the housing; wherein: (i) the third end includes a second intermediate drive device that may be in communication with the first intermediate drive device when the housing is attached to the nose sub-assembly, and (ii) the fourth end of the nose sub-assembly includes a fastener driving mechanism that is used for driving a fastener into an object, the fastener driving mechanism being in communication with the second intermediate drive device; and (e) a quick release latching mechanism, wherein: (i) when the housing and the nose sub-assembly are brought together, the quick release latching mechanism becomes engaged to hold the housing and the nose sub-assembly together, such that the first and second intermediate drive devices may operate in communication with one another, and such that the fastener driving mechanism may be driven by the prime mover device through the first and second intermediate drive devices; and (ii) when disengaged, the quick release latching mechanism allows the nose sub-assembly to readily detach from the housing, wherein the first and second intermediate drive devices may separate without damage to one another.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a side elevational view of a hand-held screw driving tool that has a detachable nose sub-assembly, in which this nose sub-assembly is used as a single-feed screw driving attachment, as constructed according to the principles of the present invention.

FIG. 2 is a perspective view from the side and rear of the tool of FIG. 1, showing a torque limiting adjustment dial.

FIG. 3 is a perspective view from the side and front of the tool of FIG. 1.

FIG. 4 is a perspective view from the side and front of the tool of FIG. 1, with the nose sub-assembly detached.

FIG. 5 is a side elevational view of the nose sub-assembly after it has been detached from the tool of FIG. 1.

FIG. 6 is a perspective view of the nose sub-assembly of FIG. 5.

FIG. 7 is an exploded view of the nose sub-assembly of FIG. 5.

FIG. 8 is a side elevational view of a second embodiment hand-held screw driving tool which has a detachable nose sub-assembly, and in this second embodiment the nose sub-assembly has an automatic feed function that allows it to receive a collated strip of screws and to automatically feed one of those screws to a driving position, as constructed according to the principles of the present invention.

FIG. 9 is a side elevational view of the second embodiment tool of FIG. 8, showing the nose sub-assembly detached from the main body.

FIG. 10 is an exploded view in partial cross-section of the tool of FIG. 8.

FIG. 11 is an exploded view of a drive bearing and latching mechanism used in the tool of FIG. 8.

FIG. 12 is an exploded view of some of the major components used in the nose sub-assembly of the tool of FIG. 8.

FIG. 13 is an exploded view of an automatic feed mechanism used in the nose sub-assembly of the tool of FIG. 8.

FIG. 14 comprises several views of a drive shaft used in the tool of FIG. 8.

FIG. 15 is an exploded view of a sprocket and feed pawl used in the feed mechanism of FIG. 13.

FIG. 16 is another exploded view from a different perspective of the sprocket and feed pawl components of the feed mechanism of FIG. 13.

FIG. 17 is a perspective view of a third embodiment hand-held screw driving tool, constructed according to the principles of the present invention, in which the handle is at the rear-most portion of the tool, and the torque limiting control is on top of the tool body.

FIG. 18 is a perspective view of the hand-held tool of FIG. 17, depicting the nose sub-assembly detached from the main body.

FIG. 19 is a perspective view of the hand-held tool of FIG. 17, depicting the nose sub-assembly detached from the main body, illustrated from a different perspective angle.

FIG. 20 is an exploded view of a torque adjustment sub-assembly used in the hand-held tool of FIG. 17.

FIG. 21 is an exploded view of the torque adjustment sub-assembly of FIG. 20, illustrated from a different perspective. FIG. 22 is a side elevational view of a fourth embodiment hand-held screw driving tool, in which a shears attachment with an adapter are attached to the main body of the tool as a combination nose sub-assembly.

FIG. 23 is a perspective view of the shears attachment illustrated on the tool of FIG. 22.

FIG. 24 is a side elevational view of a fifth embodiment of a hand-held screw driving tool constructed according to the principles of the present invention, in which a detachable nose sub-assembly includes an automatic feed mechanism that has a collapsible core along with an attached collapsible nose piece.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

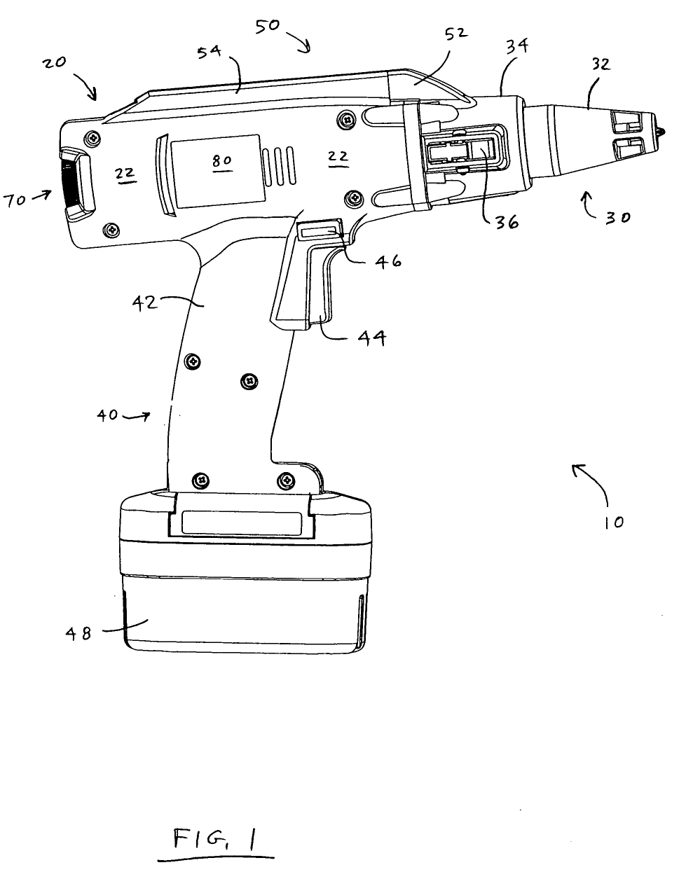

Referring now to the drawings, FIG. 1 shows a hand-held screw driving tool, generally designated by the reference numeral 10, which includes a housing portion 20, a nose sub-assembly 30, a handle portion 40, and a torque limiting control sub-assembly 70.

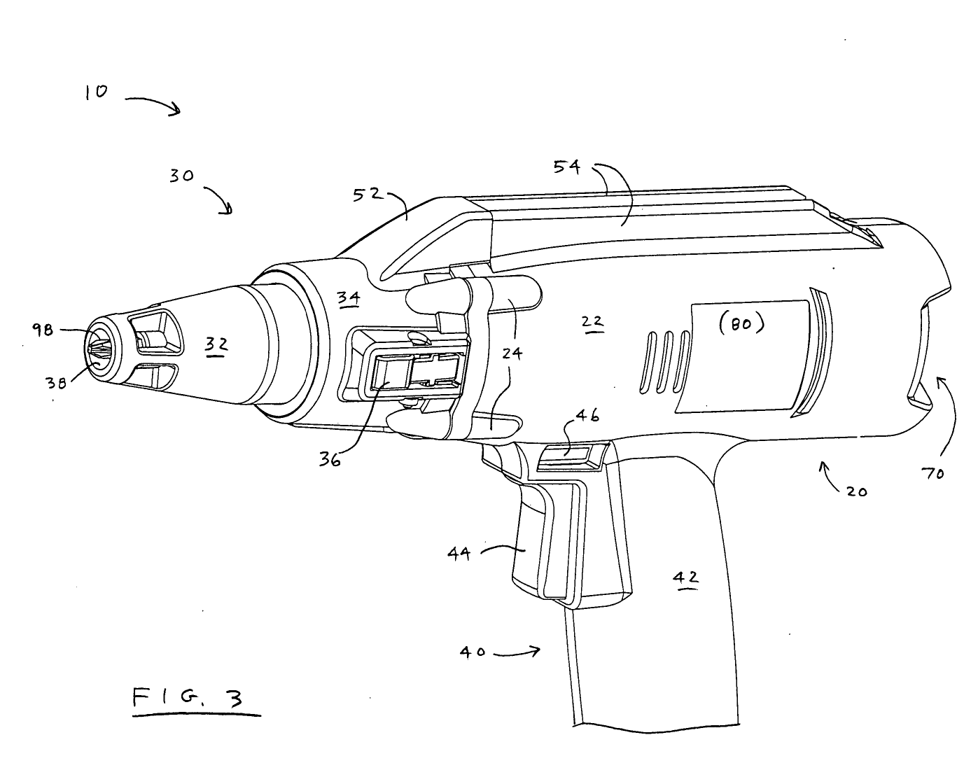

The tool 10 is designed for use with either a flexible strip of collated screws, or with a single hand-fed screw, depending upon which type of nose sub-assembly is attached to the main body. In FIG. 1, the nose sub-assembly 30 is designed for a single or individually fed screw placed near the front-most tip of the tool 38 (see also FIG. 3).

The main body of the tool includes the housing portion 20 and the handle portion 40. Housing portion 20 includes an outer shell housing structure 22 that is mated to the nose sub-assembly 30 by a quick-release latching mechanism. One purpose of the present invention is to have a relatively quick-release nose sub-assembly so it can be quickly detached from the overall tool body, and a latching mechanism 36 is used for that purpose. This will be described below in greater detail.

The nose sub-assembly 30 includes a front nose piece (or “nose cone”) 32, a housing 34 for holding the nose piece 32, and the latch sub-assembly 36. The housing portion 20 includes not only the side wall 22, but also a guide rail sub-assembly 50, in which a longitudinal pair of guide rails 54 are attached to or integral with the top of the housing portion 20. Guide rail 54 can be used to feed a flexible collated strip of screws toward the front portion of the tool, if a different nose sub-assembly were to be attached to the housing portion 20. In FIG. 1, the nose sub-assembly 30 is a single-feed device, and is not designed for use with the collated strip of screws. There is an appendage 52 that is part of the nose sub-assembly 30, which mates to the guide rail 54, but mainly is to preserve the overall look of the tool, while also eliminating sharp edges.

The handle portion 40 includes a gripable surface 42 for use by a user's hand, a trigger switch actuator 44, and a reversing switch actuator 46. Handle portion 40 also includes a detachable battery sub-assembly 48 in this version of tool 10. In FIG. 1, handle portion 40 is positioned at a mid-point of the housing portion 20, not all the way at an end.

As noted above, the screw driving tool 10 of the illustrated embodiment includes a user-settable torque limiting control, which as a sub-assembly is generally designated by the reference numeral 70 on FIG. 1. This torque limiting control can be used with an electrical circuit to limit the amount of torque that the electric motor inside the housing portion 20 will generate when driving a fastener, such as a screw. A detailed description of an electrical circuit that performs this function is provided in a companion, commonly-assigned patent application, Ser. No.______, filed on Apr. 14, 2005, titled “APPARATUS FOR CONTROLLING A FASTENER DRIVING TOOL, WITH USER-ADJUSTABLE TORQUE LIMITING CONTROL.”

However, it should be noted that the screw driving tool of the present invention need not always include a torque limiting control device, particularly if a “depth of drive” control is included in the detachable nose sub-assembly. For example, a user-adjustable mechanical depth of drive control is included in some of the embodiments described herein, and for some practical applications, it may be more desirable than a maximum torque control. For example, torque control can provide very repeatable results for fastening sheet metal-to-sheet metal structures, while depth of drive control can provide very repeatable results for fastening wood-to-wood structures.

Additional user controls can be provided as optional features on tool 10, in which these further user controls could be located at an area 80 on the side wall 22 of the housing portion 20. Such optional user controls could be located virtually anywhere on the tool, if desired, including on outer areas of the handle portion 40, for example. Such additional/optional controls are discussed in the companion patent application, noted above.

In one version of the tool 10, a modified nose cone 32 could be configured such that it would rotate about the longitudinal axis of the tool 10. This would allow a 360° adjustment of the orientation for loading a screw with the user's hand.

The quick release of the nose sub-assembly 30 allows a user to quickly expose the drive bit of the tool, and when that is exposed the user can more easily get into tight corners, remove driven screws (using the reversing trigger switch), drive individual screws, replace worn bits, and perform other functions that may require the removal of the nose sub-assembly.

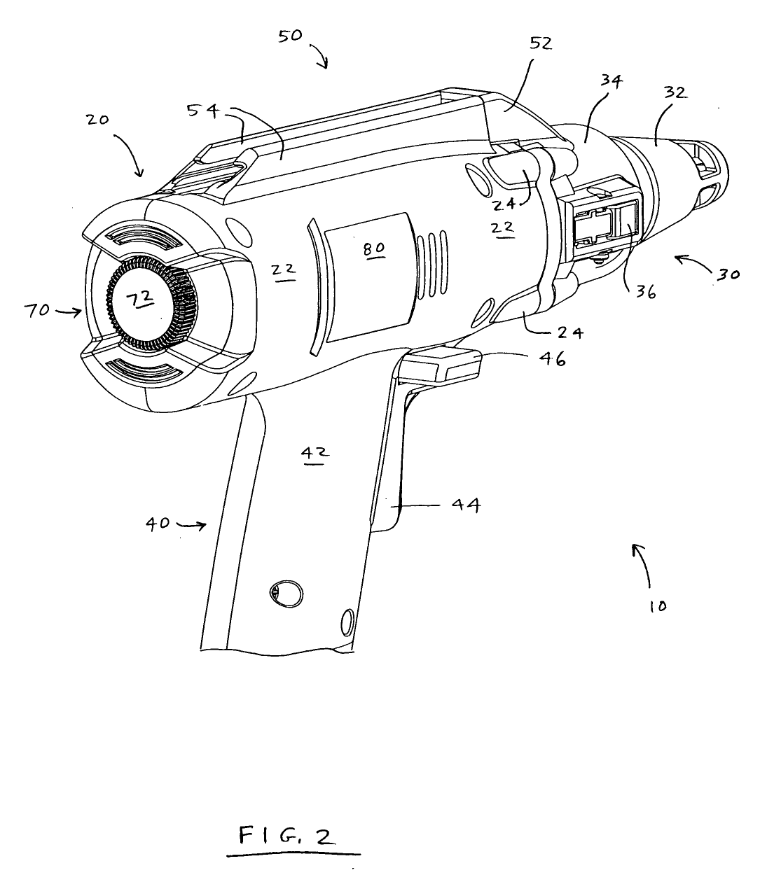

Referring now to FIG. 2, the rear portion of the screw driving tool 10 can be seen, including a wheel (or dial) 72 that is used to adjust the torque limiting value of the torque adjustment sub-assembly 70. The two halves of the guide rail portion 54 can also be seen in this view. In addition, the reversing lever 46 can be seen as protruding toward the viewer of FIG. 2.

There are some attachment bulges 24 in the housing side wall 22, which are visible in FIG. 2. Some type of fasteners, such as bolts or screws, are hidden by the attachment bulges 24, and similar bulges in the housing portion of the nose sub-assembly 34.

Referring now to FIG. 3, the front-most portion of the tool 10 is visible in this view. A Phillips drive bit 98 is visible near the front-most portion of tool 10. An opening 38 in the nose piece 32 is visible, through which drive bit 98 protrudes, which is also the location where a user will bring a fastener, such as a screw, to be driven by drive bit 98.

On this “left” side of the tool 10, an area 80 is depicted, which could be another location for providing user inputs, such as pushbuttons or a small keypad, if desired. An alternative use for this area 80 is a location for a nameplate or label identifying the tool's part number and manufacturer.

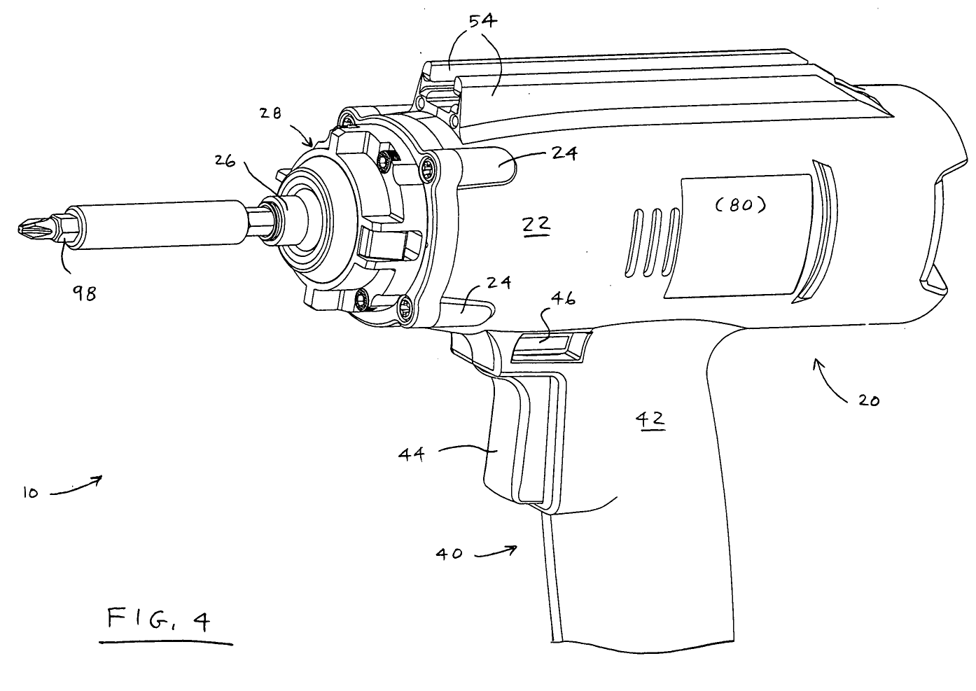

Referring to FIG. 4, the front area of the tool 10 is visible with the nose sub-assembly detached. A drive bearing sub-assembly 28 is now visible, as well as a drive shaft 26 that protrudes through the drive bearing sub-assembly 28. Also visible in this view is the front portion of the two halves of the guide rail 54. As discussed above, this guide rail 54 could be used to feed a flexible strip of collated screws, if desired. A different type of nose sub-assembly would be required, however, than that depicted in FIG. 1.

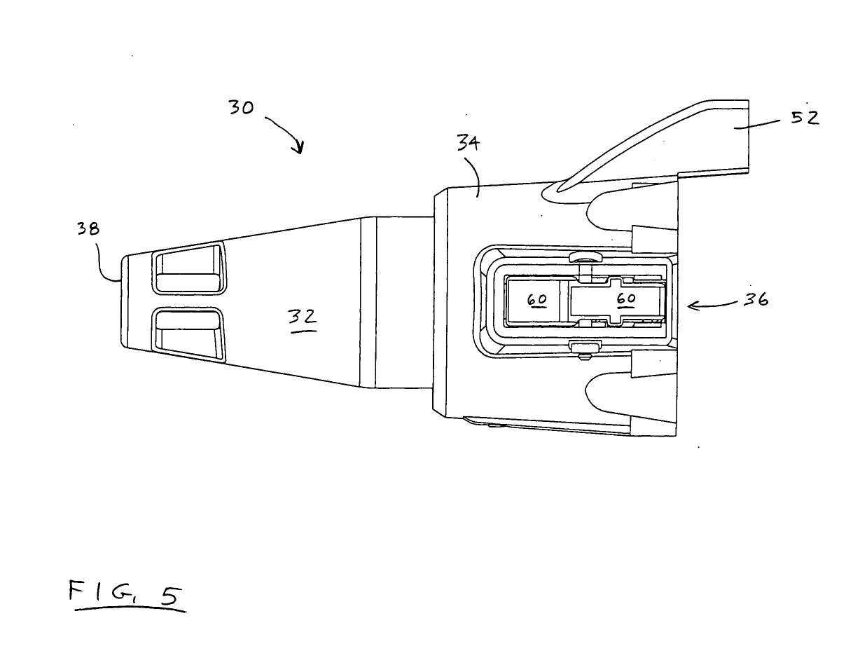

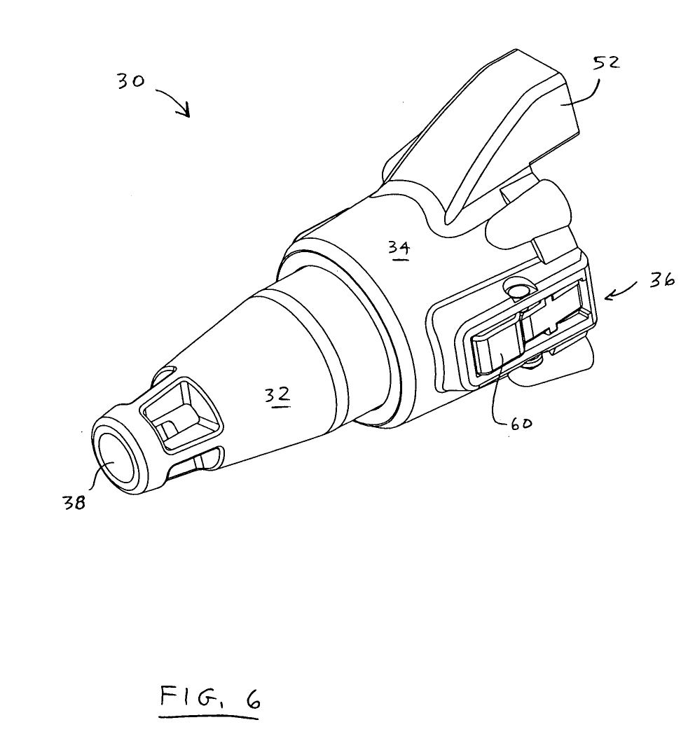

Referring now to FIG. 5, the nose sub-assembly 30 is illustrated. In this view, the latch sub-assembly 36 shows a lever 60 that is hand-operated to release the nose sub-assembly 30 from the main body of the tool 10. This lever 60 is also visible in FIG. 6, and further details will be illustrated in other views.

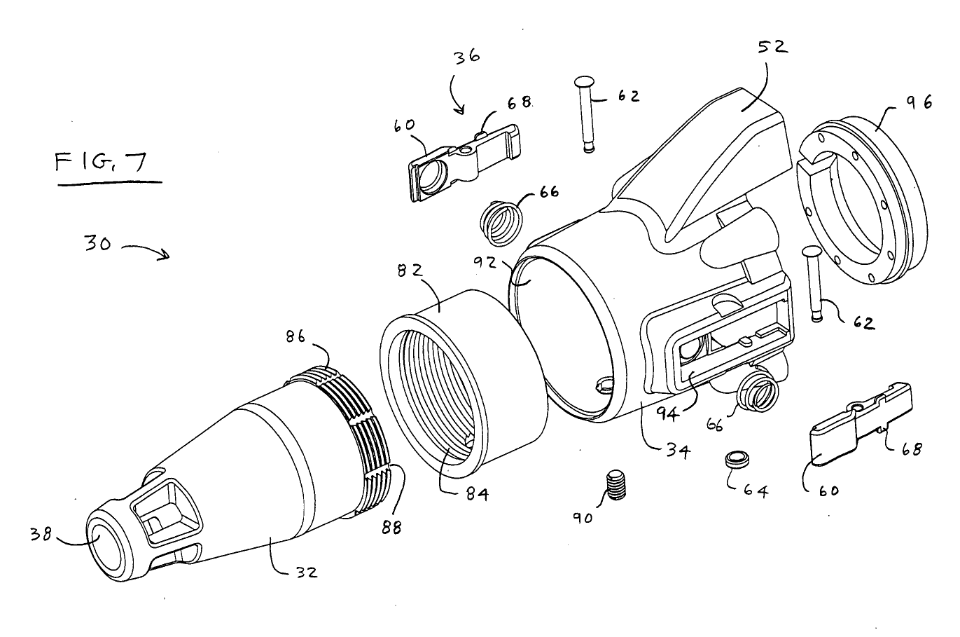

Referring now to FIG. 7, the nose sub-assembly 30 is shown in much greater detail, in which the individual components of the sub-assembly can be seen in this exploded view. The front nose piece or “nose cone” 32 has external threads 86, and there are recesses 88 in these threads. A retaining ring 82 has internal threads 84 that mate to the external threads 86 of the nose cone 32. A threaded ball detent 90 is screwed into the bottom surface of the housing 34, which mates against one of the recesses 88 to prevent the nose cone 32 from unthreading.

The retaining ring 82 is placed through an opening 92 in the housing 34, and the threads 86 of the nose piece 32 may bottom out against a spacer 96 that is attached (using a snap fit) into the rear portion of the housing 34. The threaded nose cone 32 may be screwed into the retaining ring 82 to various depths within that retaining ring, up to a maximum distance where the nose cone 32 will indeed bottom out against spacer 96. The adjustable linear distance which the nose cone threads 86 engage the retaining ring threads 84 acts as a “depth of drive” control, which determines how far the tool 10 will attempt to drive a fastener, such as a screw.

The components that make up the latch sub-assembly 36 are illustrated, including a lever 60, a hinge pin 62 (one on each side, which mate with an opening in the lever 60 on each side), a small coil spring 66 on each side, and a retainer 64 for each pin 62. Each of the levers 60 has a protrusion referred to as a “wing” 68, which helps to retain the latch lever in its proper position within a recess 94 in the housing 34. The retainer 64 is essentially a grommet, in one mode of the present invention.

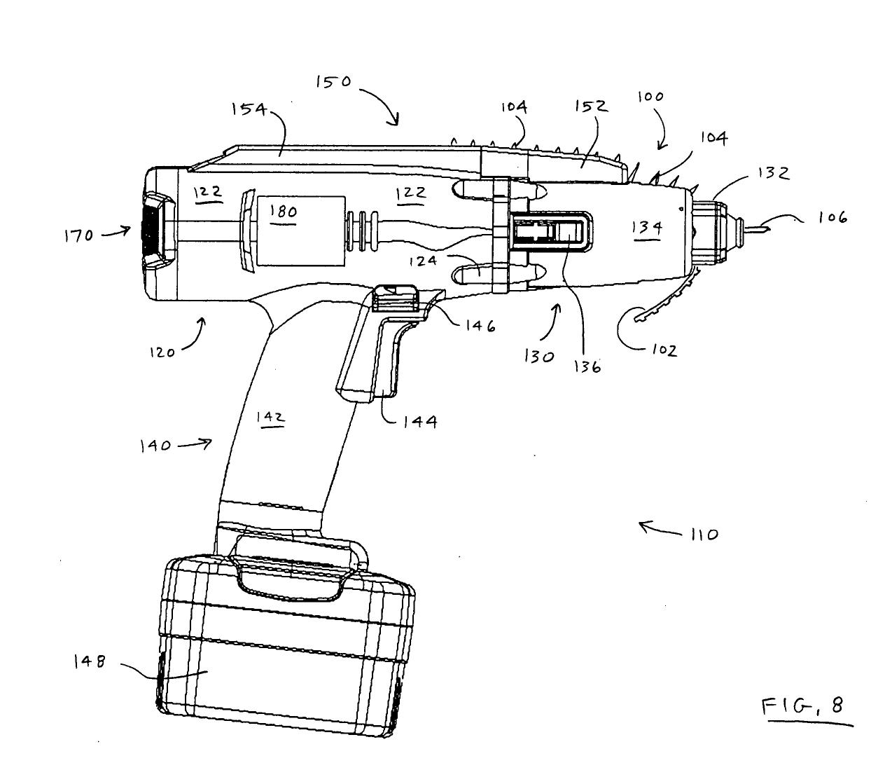

Referring now to FIG. 8, a second embodiment of a hand-held screw driving tool is illustrated, generally designated by the reference numeral 110. Tool 110 has similarities to the first embodiment tool 10 depicted in FIGS. 1-7, however the nose sub-assembly 130 on FIG. 8 is designed to receive a flexible strip of collated screws. Therefore, the nose sub-assembly 130 acts as an automatic feed device, when that collated strip of screws is inserted. On FIG. 8, the collated strip of screws is a sub-assembly generally designated by the reference numeral 100, and includes a plastic strip 102 that has openings for holding fasteners, such as screws, and which is visible beneath the front-most portion of the tool 110. The collated strip sub-assembly 100 has multiple screws 104, which individually are indexed to a forward or “lead position” at 106, also sometimes referred to herein as the “drive position” or “driving position.”

Tool 110 includes a housing portion 120 which has a side wall 122 and attachment bulges 124. The nose sub-assembly 130 includes a housing 134 and a front nose piece 132. Nose sub-assembly 130 also includes a latch sub-assembly 136, which can be very similar or identical to the latch sub-assembly 36 on the tool 10.

The second embodiment tool 110 also includes a handle portion 140, with a gripable area 142, and which includes a trigger actuator 144 and a reversing lever 146. The bottom of the handle portion 140 has a detachable battery pack 148. An area 180 can be used as a location to position additional user inputs, if desired. A torque adjustment sub-assembly 170 is located in the rear-most portion of the housing portion 120.

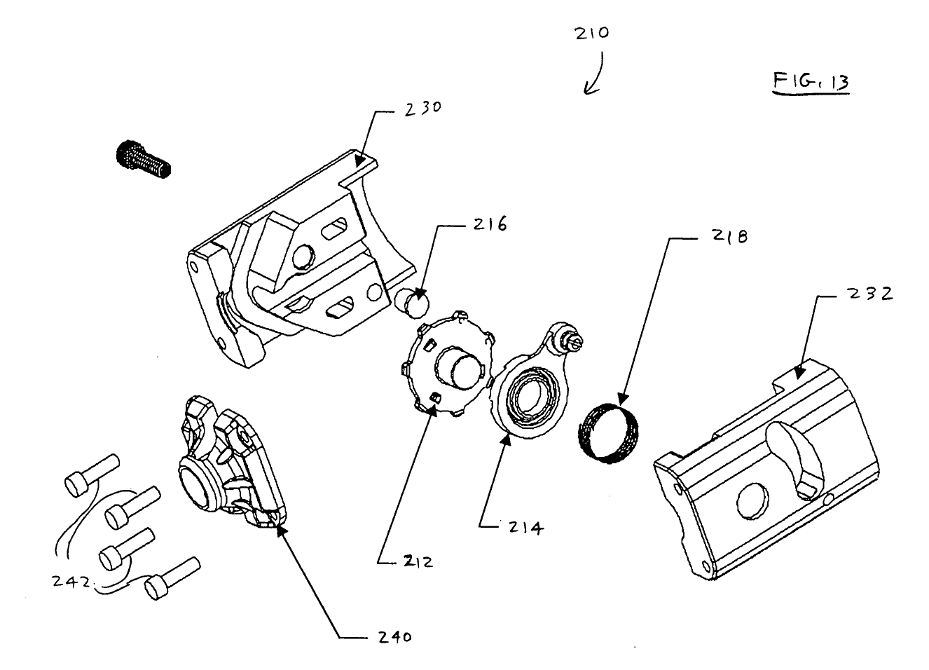

The upper area of the housing portion 120 includes a guide rail sub-assembly 150, including a rear portion 154 and a forward portion 152. The forward portion 152 is part of the housing 134, while the rear portion 154 is part of the housing portion 120. The two portions 152 and 154 are designed to be essentially co-linear, so that a collated strip of screws can be fed from the rear opening of the guide rail 154 and then indexed toward the front area of the guide rail 152, all the way to the indexing mechanism (see FIG. 13) within the nose piece 132 of the nose sub-assembly 130.

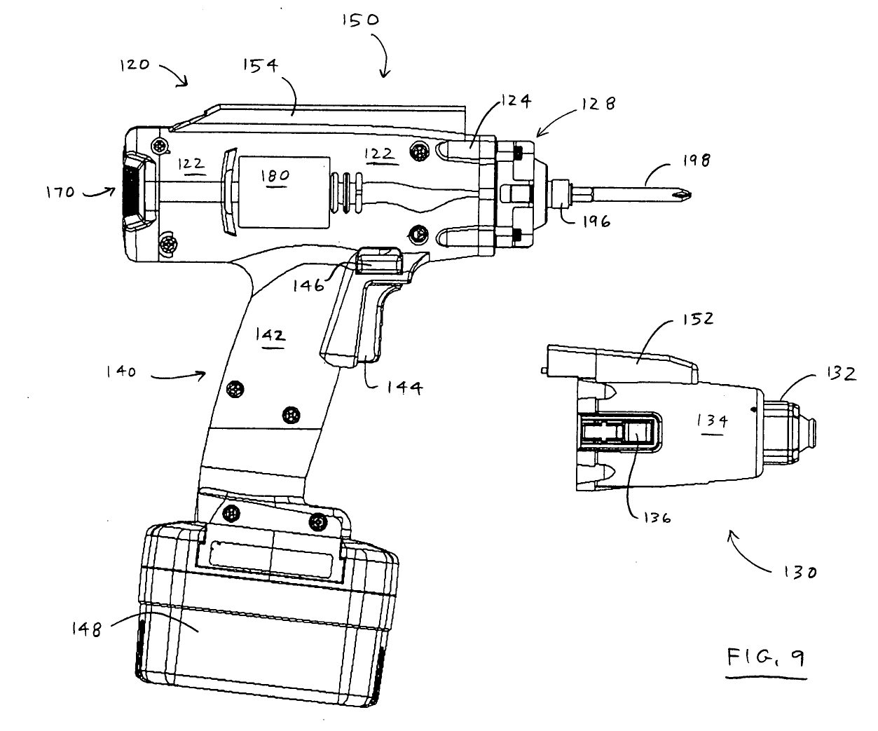

FIG. 9 shows the second embodiment tool 110 with the nose sub-assembly 130 detached from the main body. In FIG. 9, a drive bit 198 is visible, and is shown as being attached to the tool's main body using a chuck 196, as a bit release and retaining device. A drive bearing sub-assembly 128 is visible, and is attached using fasteners that are hidden behind the attachment bulges 124.

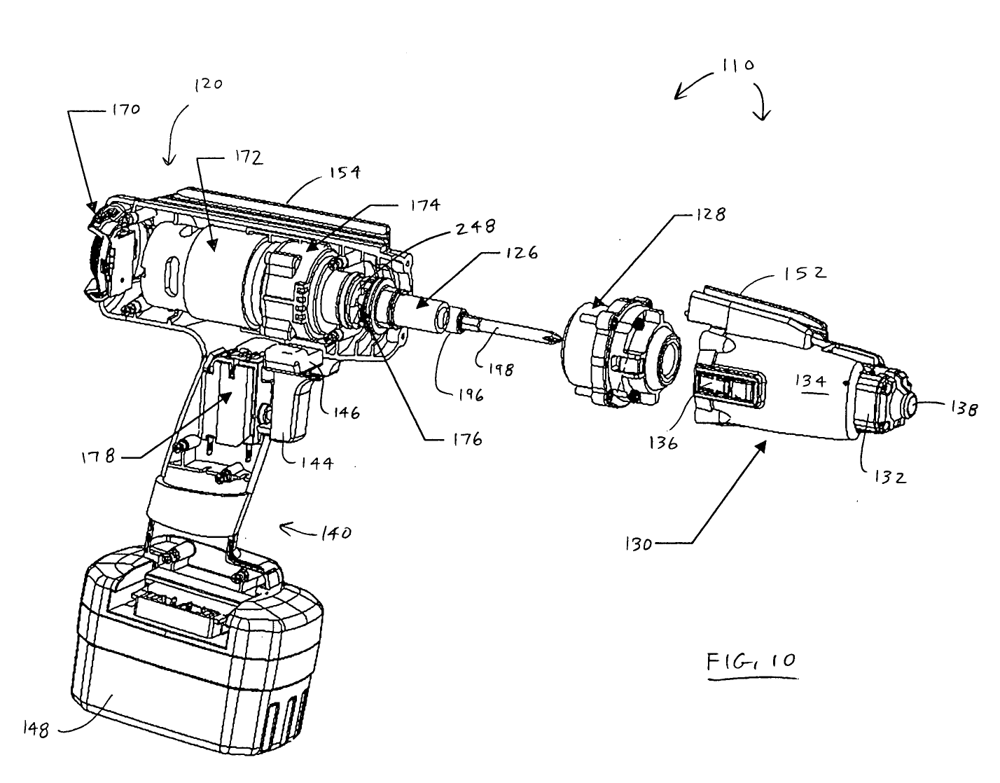

Referring now to FIG. 10, some of the internal components are visible in this exploded view of the second embodiment tool 110. A motor 172 is contained within the housing portion 120, and the motor is in mechanical communication with a gear box 174, which is in mechanical communication with a clutch 176. An electrical reversing switch 178 is visible within the handle portion 140. This switch 178 is actuated by the trigger actuator 144 and the reversing lever 146. A drive shaft 126 is visible, which is in mechanical communication with the drive bit 198 using the chuck 196.

The front-most opening 138 in the nose sub-assembly 130 is visible in FIG. 10, and this is where a screw or other type of fastener will protrude as it is being driven into an object. This refers to a screw at the “driving position” 106 on FIG. 8.

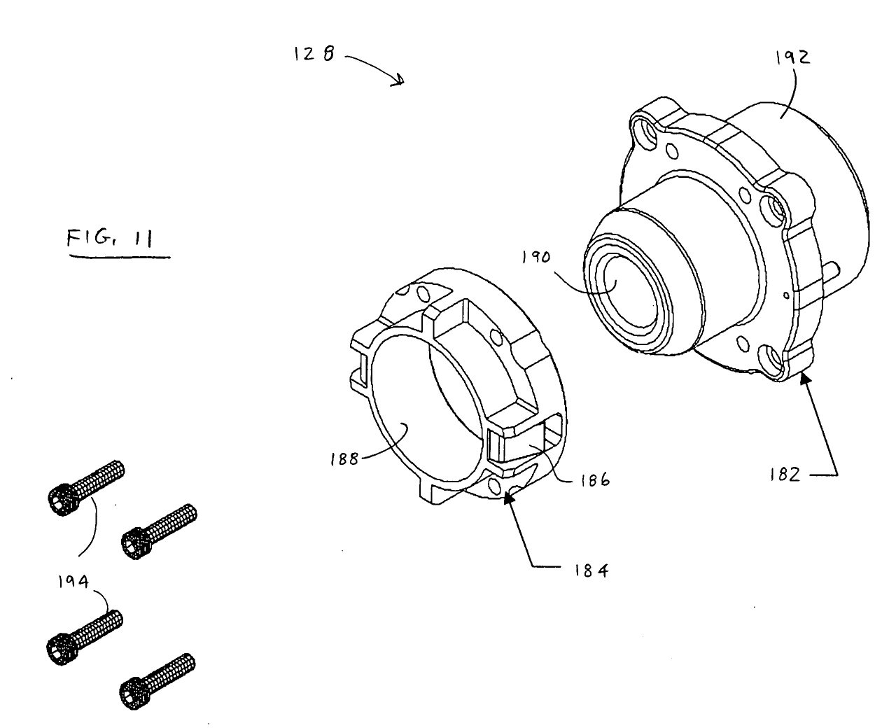

Referring now to FIG. 11, the drive bearing sub-assembly 128 is depicted showing its bearing housing 182 and an adapter ring 184. The adapter ring 184 includes a ramp structure 186, which is used to make mechanical contact with the lever 160 of the latch sub-assembly 136. By use of this ramp 186, a nose sub-assembly 130 can be slid into position without having to apply any force to the latching lever 160, because the end of the lever slides over the ramp 186 automatically and is deflected by that ramp during installation (or attachment) of the nose sub-assembly. Once the lever has fully passed across the entire length of the ramp 186, then a coil spring (e.g., spring 66 on FIG. 7) will force the lever 160 into a latching position just past the far end of the ramp. Then to release the lever 160, the user will press on the opposite end of that lever so that the ramp 186 can be cleared, and then the nose sub-assembly 130 can be easily detached from the body portion 120. It will be understood that many other configurations of a quick-release and a quick-install latching mechanism would readily work to attach and detach the nose sub-assembly, without departing from the principles of the present invention.

An opening 188 in the adapter ring is sized to be positioned over a portion of the drive bearing 192. An opening 190 in the drive bearing is sized to allow a drive bit to pass therethrough. The adapter ring 184 is attached to the drive bearing housing 182 by use of screws 194. Note that portions of the drive bearing sub-assembly 128 (e.g., including the drive bearing housing 182 and the adapter ring 184) could be constructed as a unitary structure, if desired.

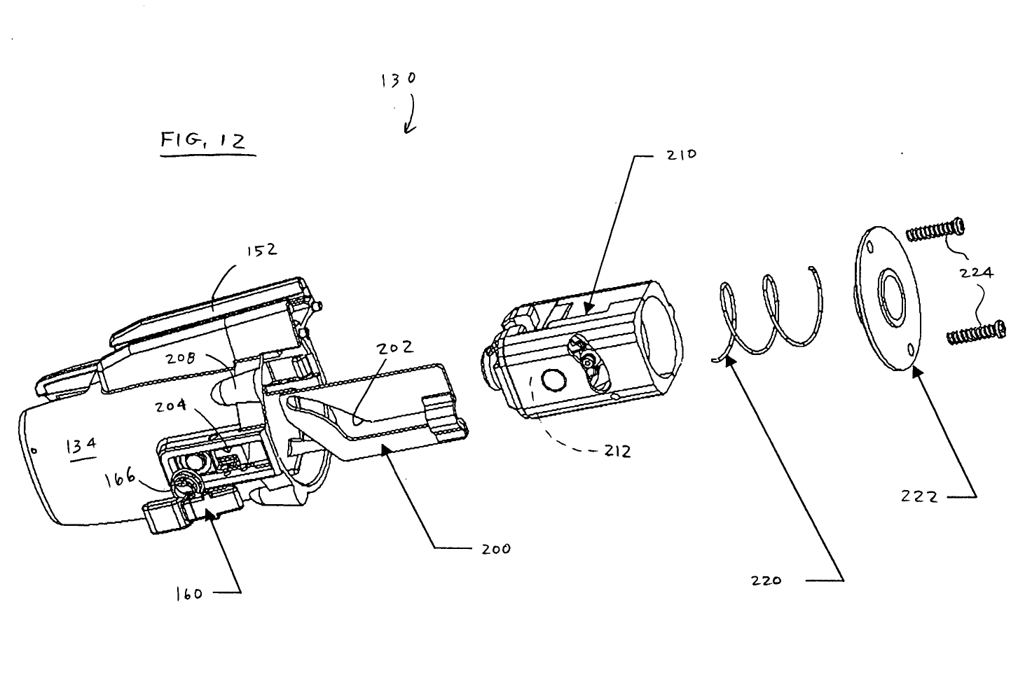

Referring now to FIG. 12, the nose sub-assembly 130 is illustrated in an exploded view to see some of the internal components. The latching lever 160 is visible, along with its associated coil spring 166. The latching lever 160 fits into a recess 204 and the housing 134.

The housing 134 includes an attachment bulge 208, and the front portion of the guide rail 152. A cam plate 200 is included, which has a cam guide 202 for use with a movable feed mechanism sub-assembly 210.

Feed mechanism 210 includes an indexing sprocket 212, which is not visible in FIG. 12 but can be seen in other views. A return spring 220 and a spring plate 222 are visible, which are held into the feed mechanism 210 by screws 224.

Referring now to FIG. 13, the feed mechanism sub-assembly 210 is illustrated in an exploded view to see some of its internal components. This feed mechanism includes a slide body sub-assembly that has a slide body cover 230 and a slide body support 232, on opposite sides of the mechanism 210. Within this mechanism 210 are an indexing sprocket 212, a feed pawl 214, a ball plunger 216, and a feed pawl spring 218. A front nose piece 240 attaches on the front portion of the feed mechanism 210, using screws 242. The operation of their parts is described in greater detail in U.S. Pat. No. 5,988,026, co-assigned to Senco Products, Inc., DuraSpin LLC division.

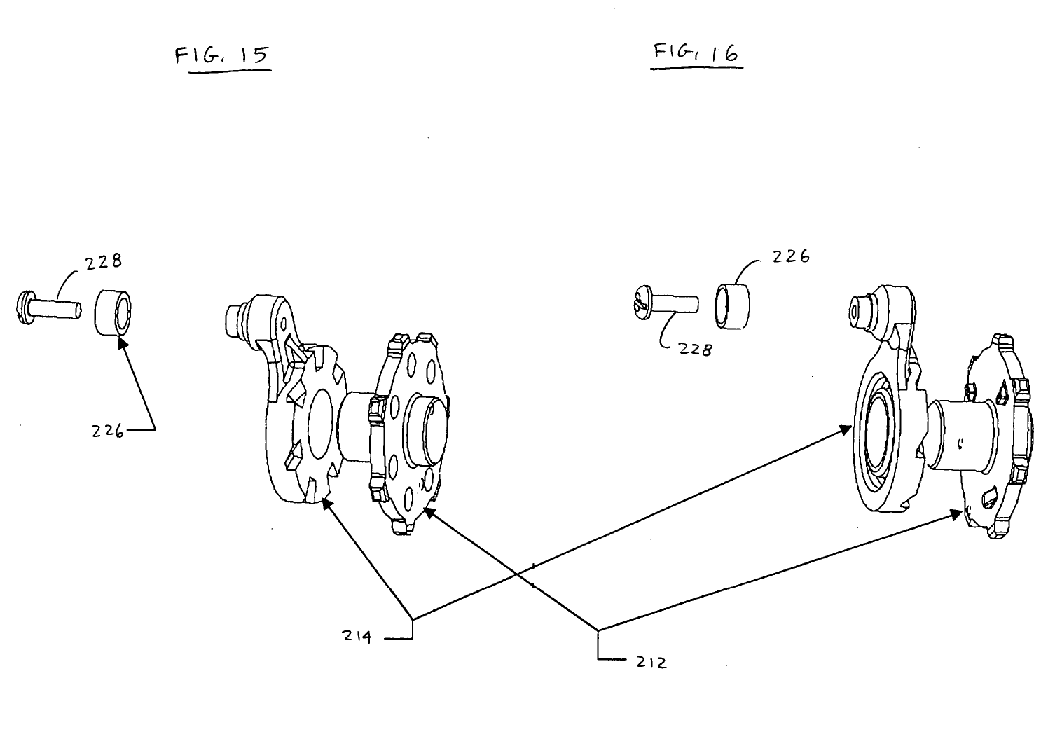

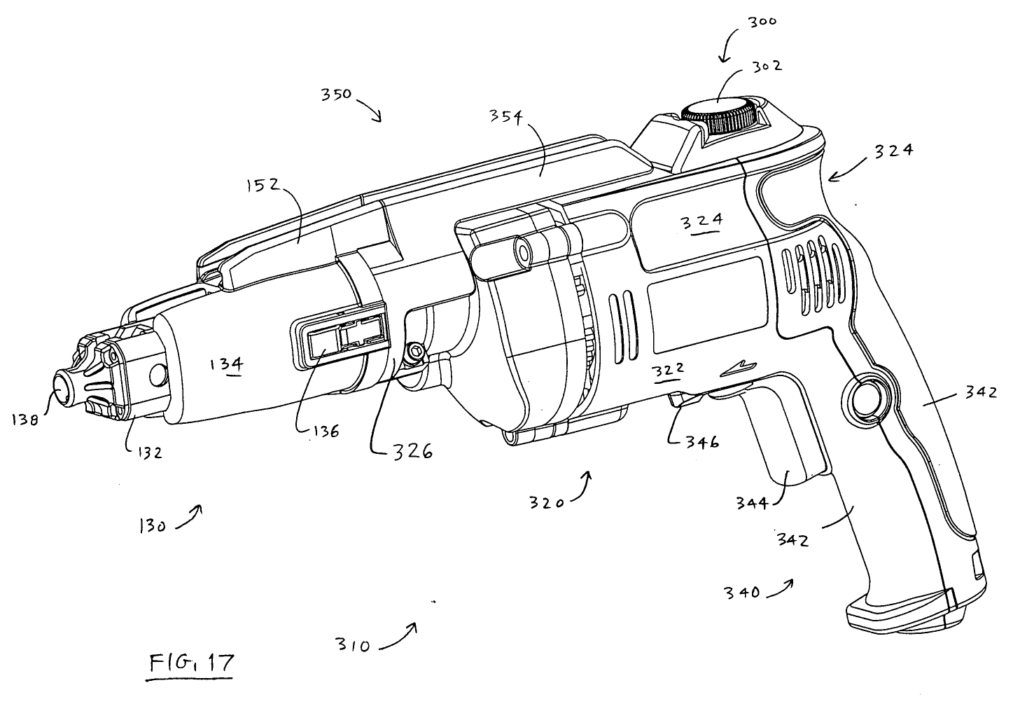

Referring now to FIGS. 15 and 16, the feed pawl 214 and the sprocket 212 are illustrated in their orientation to one another, as well as a cam follower 226, and a fastener used in the cam sub-assembly 228.

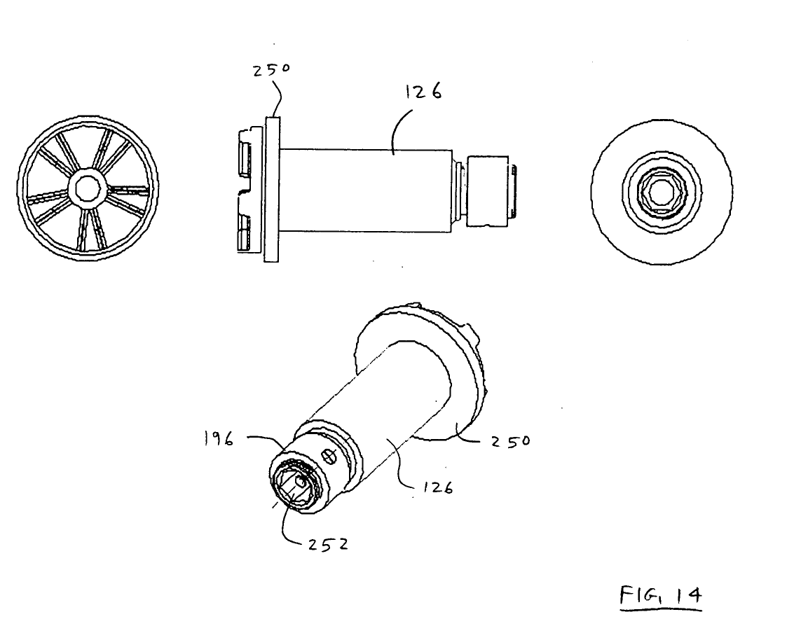

Referring now to FIG. 14, the drive shaft 126 is illustrated as being attached to a driven portion 250 of the clutch 176. A recess 252 is included in the chuck 196, and this recess receives the drive bit 198. Note that, in many embodiments of the present invention, the driven portion 250 of the clutch 176 is not in direct contact at all times with the drive portion 248 (see FIG. 10) of the clutch. Typically the tool must be actuated before the drive and driven members of the clutch 176 actually become engaged.

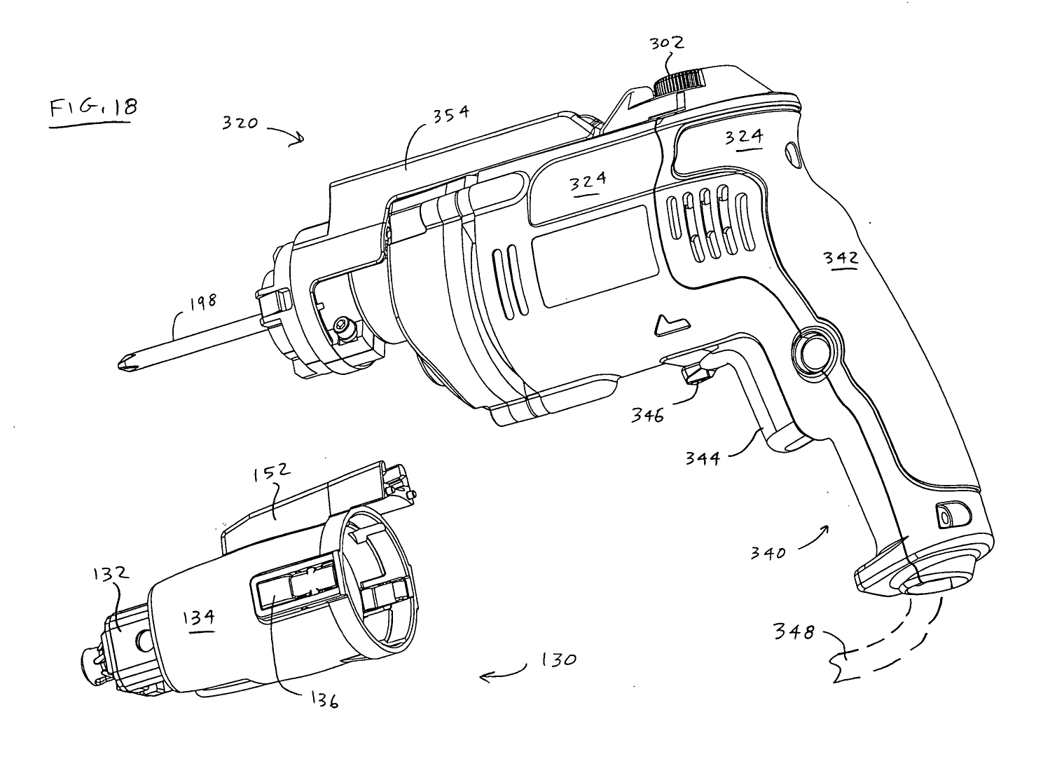

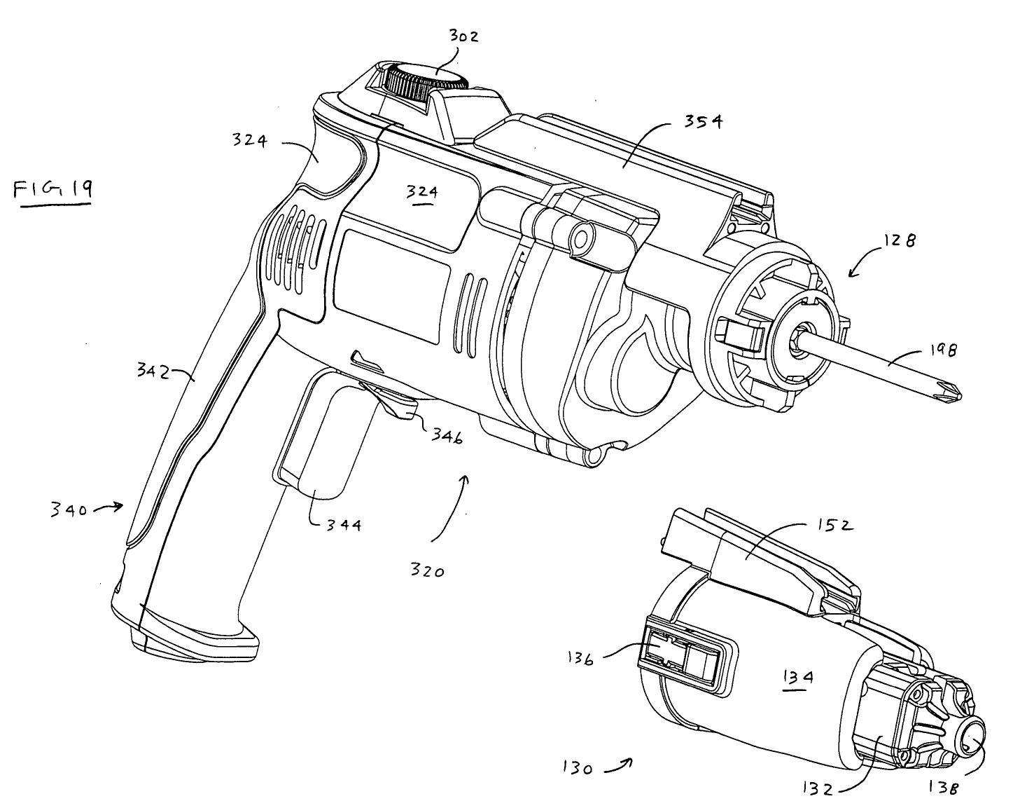

Referring now to FIG. 17, a third embodiment of a hand-held screw driving tool is illustrated, generally designated by the reference numeral 310. In this embodiment 310, the handle portion 340 is all the way to the rearwardmost portion of the housing 320. In addition, the torque limiting sub-assembly at 300 is positioned on a top area near the rear of the housing 320. A torque dial (or wheel) adjustment is designated at 302.

The housing portion 320 includes a side wall 322. Moreover, some recesses 324 are made in the housing for placement of the fingers of a user's hand when using the tool 310. A handle portion 340 includes a set of grip areas 342, a trigger actuator 344, and a reversing lever 346. Either a battery pack or an electrical power cord can be attached to the bottom of the handle portion 340 (such as a power cord at 348).

This third embodiment tool 310 includes an adapter 326 that mates to the front of the housing portion 320, and also mates to the nose sub-assembly 130. This adapter 326 allows a “standard” screw driving tool (i.e., one that was not designed for use with collated screws) to be quickly converted into a tool that is capable of receiving a strip of collated screws, and then allows for automatic feed operation to drive individual screws from the collated strip. Tool 310 includes a guide rail sub-assembly 350, that is made up of a rear portion 354 that is part of the tool's adapter 326, and a front portion 152. As can be seen in FIG. 17, the rear portion guide rail 354 does not extend all the way along the top length of the housing portion 320, since the torque limiting sub-assembly 300 is placed also along the top of the housing.

The tool 310 is depicted as having a nose sub-assembly 130 that is used for receiving a collated strip of screws, and which includes an automatic feed mechanism. This is the same nose sub-assembly 130 that was seen in the second embodiment. This illustrates the fact that various different types of tool bodies can be used with various types of nose sub-assemblies, all of which are contemplated in the present invention. Note that many “standard” screw driving tools can be used with an adapter, such as the adapter 326, and thus be converted into an automatic feed tool, with or without the torque limiting device 300.

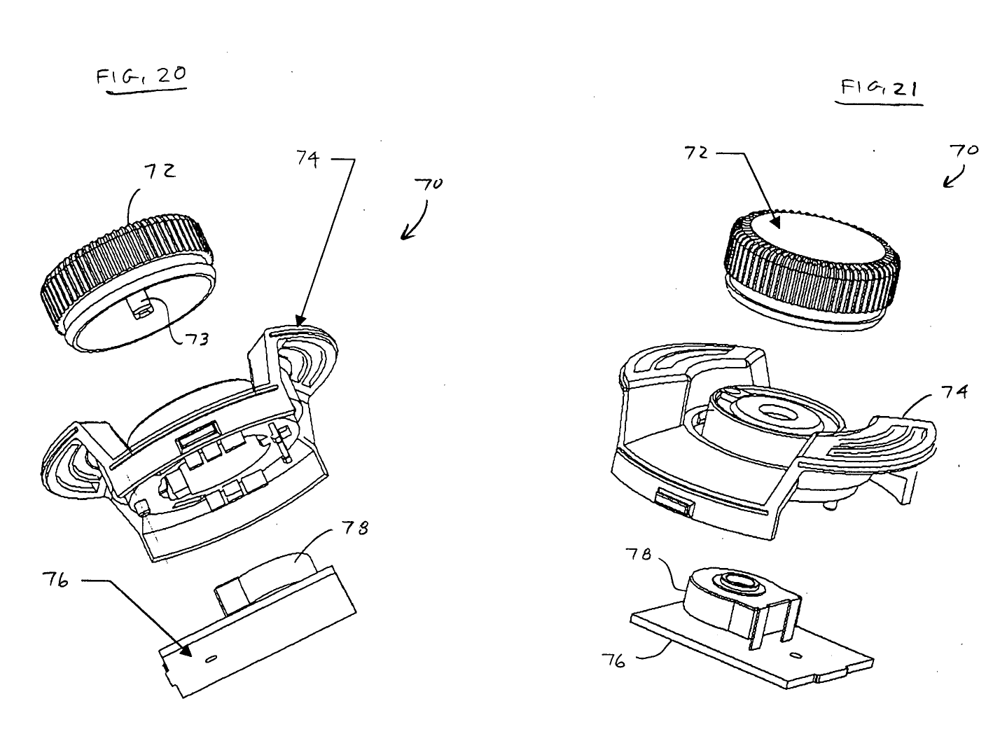

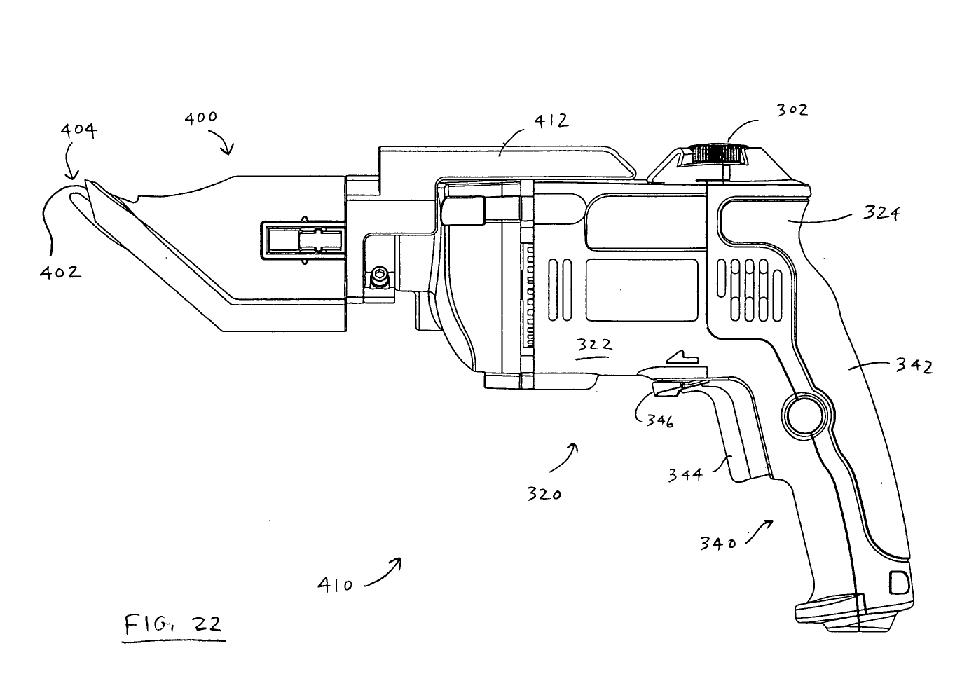

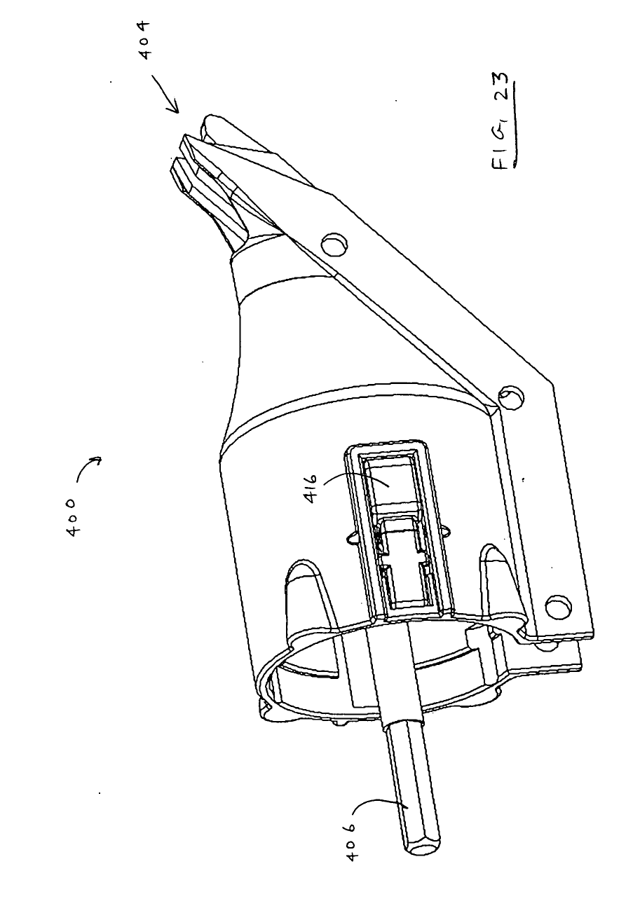

Referring now to FIGS. 20 and 21, the torque limiter control sub-assembly 70 is illustrated in greater detail. A user-actuatable dial or wheel 72 is mounted into a torque wheel housing 74. This housing 74 covers a printed circuit board 76 which has a potentiometer 78 mounted thereon. In this embodiment, the electrical component used as an input device for the user torque limit setting is the potentiometer 78, which is rotated by a stem portion 73 that is part of the adjustment wheel or dial 72. Certainly other types of mechanical and/or electrical components could be used as the input device for the torque limit setting that can be actuated by a user. For example, an optical sensor could be used with some type of slotted encoder wheel, or perhaps a magnetic pickup sensor could be used if the wheel has either magnetic or soft iron metal characteristics. A pure mechanical component alternatively could be used, if a mechanical feature was to be the actual torque limiting device.

Referring now to FIG. 22, a fourth embodiment of a hand-held portable tool is generally designated by the reference numeral 410. This tool 410 is not a screw driving tool, but instead is used for cutting sheet metal. The front portion of the tool is a cutter sub-assembly 400, which includes a set of mechanized shears (or other type of cutting surfaces) 404 at the front-most portion of the attachment nose sub-assembly 400. This shears attachment sub-assembly 400 includes a base surface 402, that can be slid along the surface of the sheet metal that is being cut.

The tool of the fourth embodiment 410 can include virtually any of the main bodies discussed herein, and in FIG. 22 the main body includes the housing 320 and the handle portion 340 (from the third embodiment), in which the handle is located to the rearmost section of the housing portion 320. The torque limiting dial 302 again is placed on the top surface of the housing.

In this fourth embodiment tool 410, an adapter rail 412 is used to help in attaching the shears attachment sub-assembly 400 to the tool main body. (The rail 412 acts as a mechanical adapter between the main body of the tool {e.g., the housing 320} and the shears attachment sub-assembly 400.)

Referring now to FIG. 23, the shears sub-assembly 400 is illustrated in greater detail, and shows a latch sub-assembly 416 and a drive shaft 406. In the illustrated embodiment, drive shaft 406 receives rotary motion from the tool main body, and converts that into lateral motion for driving the blades or cutting surfaces 404 of the shear attachment 400.

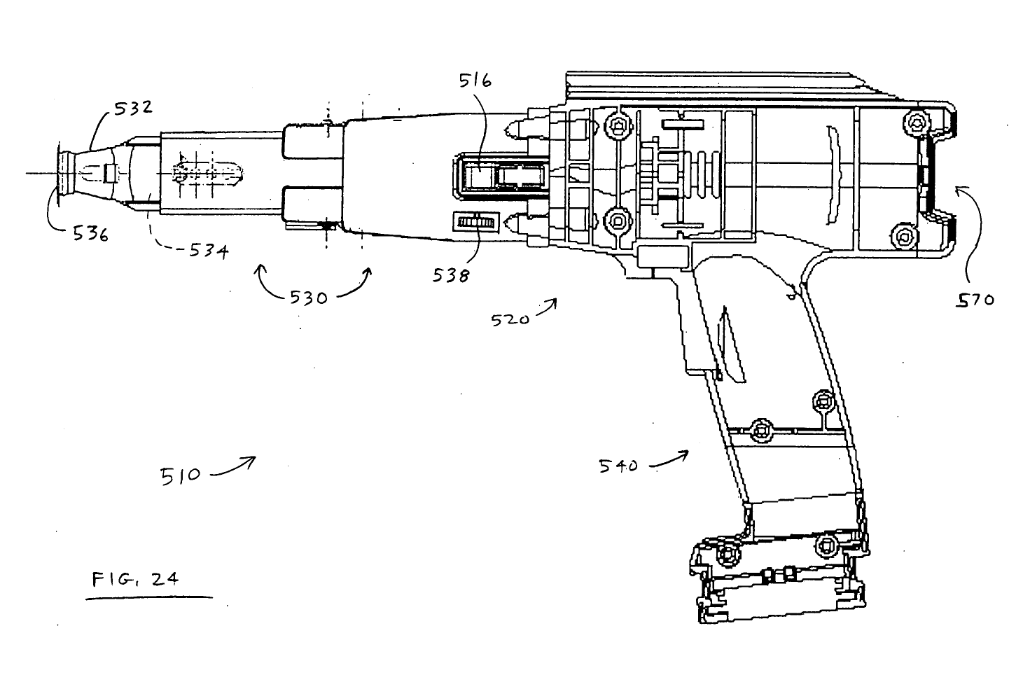

Referring now to FIG. 24, a fifth embodiment of a hand-held screw driving tool is illustrated, generally designated by the reference numeral 510. Tool 510 includes a housing portion 520, a handle portion 540, and a detachable nose sub-assembly 530. A torque limiting adjustment sub-assembly 570 is located at the rear-most area of the housing portion 520. The housing portion 520 is attached to (or detached from) the nose sub-assembly 530 by use of a latch sub-assembly 516.

In FIG. 24, the nose sub-assembly 530 has a movable nose portion, similar to many of the screw driving tools that have been sold by Senco Products, Inc. in the past. This movable nose portion includes a front-most nose piece 532 that extends forward to a front surface 536, which is used to abut a surface that a fastener is to be driven into; and it includes a slide body sub-assembly 534 is located in the nose piece area, but which is hidden by nose piece 532 in this view of FIG. 24. A fastener is driven into an object when the tool 510 is pressed against a solid object (while the tool's trigger is actuated), which in effect slides the movable nose portion into the remainder of nose sub-assembly 530.

If desired, this type of nose sub-assembly 530 can include a depth of drive adjustment 538. This depth of drive adjustment could be used instead of a torque limiting control, or both could be used on the same tool, if desired.

The fifth embodiment tool 510 can be configured so that the indexing mechanism in the slide body sub-assembly 534 works in an “index on advance” mode of operation. In this mode, the “lead screw” is not indexed to its driving position until the user places the front surface 536 of the nose piece 532 against a solid object, and begins to push the tool 510 into that solid object. This is not a requirement, but it is similar to how other Senco Products DURASPIN tools work with this type of nose piece configuration.

On the other hand, the second embodiment 110 illustrated in FIG. 8 can be provided with a nose sub-assembly 130 that works in an “index on return” mode, in which a lead screw is fed into the driving position just after the previous lead screw has been driven into a solid object. These above types of indexing modes are optional, and either mode can be used for virtually any type of nose sub-assembly, if desired by the designer.

It will be understood that the principles of the present invention are applicable to many different types of fastener driving tools, including tools powered by AC electrical power (e.g., 120 VAC line power from an outlet), DC electrical power (e.g., from a battery or a solar panel), a pneumatic power source, or a hydraulic power source, for example. Each of these tools would include some type of prime mover device to provide the power/motion needed to rotate a fastener at the “driving position” of the tool. Such a prime mover device could comprise an electric motor (e.g., motor 172 of tool 110), a pneumatic motor, a pneumatic pump, a hydraulic pump, or a hydraulic motor, for example. In addition, the clutch used to transmit power from the housing to the nose sub-assembly could comprise a mechanical clutch, such as that depicted in FIG. 14, or it could perhaps comprise a hydraulically-powered device or a pneumatically-powered device, if desired for use with a hydraulic or pneumatic prime mover device.

It will also be understood that the term “collated screw sub-assembly” as used herein refers to a strip of screws that are temporarily mounted in a flexible strip of material that exhibits openings and other structures to hold the screws in place until they are needed. In many products, the flexible strip of material comprises plastic, but other materials could be used, if desired. The individual screws are advanced to a driving position in a screw driving tool (such as portable tool 10), and each screw is individually driven from the flexible strip by the tool when the tool is actuated.

It will be further understood that the term “fastener” as used herein may refer to many different types of devices, including bolts, wood screws, sheet metal screws, concrete screws, and the like. In addition, the types of fasteners that can be driven in the manner of the present invention are not limited to screws or bolts, but could instead be rivets, for example. Various types of screws are available with different types of heads, and with different types of “drive” shapes, such as a Phillips head, or a head having a square recess. All of these various types of fasteners can be used in the present invention. In general, fastener-driving tools in the same technical field as the present invention have always been able to drive screws and the like, and for the purposes of this patent document, the term “screw” can have an expanded meaning to include other types of fasteners.

Some of the mechanical mechanisms described above for the portable screw driving tool 10 has been available in the past from Senco Products, Inc. Some of the components used in the present invention have been disclosed in commonly-assigned patents or patent applications, including a U.S. Pat. No. 5,988,026, titled SCREW FEED AND DRIVER FOR A SCREW DRIVING TOOL; a U.S. patent application titled TENSIONING DEVICE APPARATUS FOR A BOTTOM FEED SCREW DRIVING TOOL FOR USE WITH COLLATED SCREWS, filed on Sep. 29, 2004, having the Ser. No. 10/953,422; a U.S. patent application titled SLIDING RAIL CONTAINMENT DEVICE FOR FLEXIBLE COLLATED SCREWS USED WITH A TOP FEED SCREW DRIVING TOOL, filed on Oct. 13, 2004, having the Ser. No. 10/964,099; and a U.S. patent application titled METHOD AND APPARATUS FOR COOLING AN ELECTRIC POWER TOOL, filed on Dec. 27, 2004, having the Ser. No. 11/023,226.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

1. A hand-held fastener-driving tool, comprising:
(a) a housing containing a prime mover device, and a first intermediate drive device that translates movement from said prime mover device toward an output end of the housing;
(b) an attachable/detachable nose sub-assembly having an input end and a final drive end, wherein when said nose sub-assembly is mated to said housing, said input end is positioned proximal to said output end of the housing; said nose sub-assembly being configured to receive a collated strip of fasteners and to move a fastener of the collated strip of fasteners toward said final drive end; wherein:
(i) said input end includes a second intermediate drive device that may be in communication with said first intermediate drive device when said housing is attached to said nose sub-assembly, and
(ii) said final drive end of the nose sub-assembly includes a fastener driving mechanism that is used for driving said fastener into an object, said fastener driving mechanism being in communication with said second intermediate drive device; and
(c) a quick release latching mechanism, wherein:
(i) when said housing and said nose sub-assembly are brought together, the quick release latching mechanism becomes engaged to hold said housing and said nose sub-assembly together, such that said first and second intermediate drive devices may operate in communication with one another, and such that said fastener driving mechanism may be driven by said prime mover device through said first and second intermediate drive devices; and
(ii) when disengaged, the quick release latching mechanism allows said nose sub-assembly to readily detach from said housing, wherein said first and second intermediate drive devices may separate without damage to one another.

2. The hand-held fastener-driving tool as recited in claim 1, wherein said prime mover device comprises one of: (a) an electric motor; (b) a pneumatic motor; (c) a pneumatic pump; (d) a hydraulic motor; and (e) a hydraulic pump.

3. The hand-held fastener-driving tool as recited in claim 2, wherein said electric motor is powered with electrical energy from one of: (a) a battery; and (b) a power cord.

4. The hand-held fastener-driving tool as recited in claim 1, wherein said latching mechanism comprises: (a) a spring-loaded lever having a catch on one end; (b) a hinge pin that is positioned though an opening in said lever, and which holds said lever to one of said housing and said nose sub-assembly; and (c) a ramp structure on one of said housing and said nose sub-assembly, said ramp structure having a latching edge; wherein:
(d) to attach said nose sub-assembly to said housing, said lever is slid over said ramp structure until reaching a position where said catch of the lever clears said latching edge of the ramp, and said lever pivots about said hinge pin such that said catch reaches a position against said latching edge of the ramp structure; and
(e) to detach said nose sub-assembly from said housing, said lever is pressed by a user such that the lever pivots about said hinge pin to remove said catch from making contact with said ramp structure.

5. The hand-held fastener-driving tool as recited in claim 1, further comprising: a user actuatable reversing trigger control.

6. The hand-held fastener-driving tool as recited in claim 1, further comprising: a user adjustable torque limiter control.

7. The hand-held fastener-driving tool as recited in claim 1, wherein said tool is used in at least one of the following modes of operation: (a) said nose sub-assembly is detached from said housing to expose a drive bit, and a user drives a single fastener into said object by manually holding that fastener; (b) said nose sub-assembly is attached to said housing such that a collated strip of fasteners can automatically be driven into said object; and (c) said nose sub-assembly is detached from said housing to expose a drive bit, and a user removes a fastener that had previously been driven into said object.

8. The hand-held fastener-driving tool as recited in claim 1, further comprising a guide rail structure, a first portion of said guide rail structure being located on said housing, and a second portion of said guide rail structure being located on said nose sub-assembly, such that said collated strip of fasteners is fed into said first portion of the guide rail structure and travels therethrough, then said collated strip of fasteners travels into said second portion of the guide rail structure and travels therethrough, finally arriving at said fastener driving mechanism; wherein said first and second portions of the guide rail structure may be readily separated without damage thereto, when said nose sub-assembly is detached from said housing.

9. The hand-held fastener-driving tool as recited in claim 1, wherein said nose sub-assembly operates in one of the following modes: (a) index on advance; and (b) index on return.

10. The hand-held fastener-driving tool as recited in claim 1, wherein said nose sub-assembly includes (a) a movable front-most nose piece at said final drive end, and (b) a movable slide body sub-assembly.

11. The hand-held fastener-driving tool as recited in claim 1, further comprising a handle that is positioned substantially at one of: (a) an end of said housing that is opposite from said output end; and (b) a mid-position that is between said output end and said opposite end of the housing.

12. The hand-held fastener-driving tool as recited in claim 1, wherein said nose sub-assembly comprises one of: (a) a sheet cutting attachment; and (b) an automatic feed fastener-driving attachment that operates with said collated strip of fasteners, and which includes a user-adjustable mechanical depth of drive control mounted on said nose sub-assembly; and (c) an automatic feed fastener-driving attachment that operates with said collated strip of fasteners, and which includes a user-adjustable torque limiter control mounted on said housing.

13. The hand-held fastener-driving tool as recited in claim 1, further comprising a clutch between said first and second intermediate drive devices, wherein: (a) said first intermediate drive device includes a drive side of said clutch; and (b) said second intermediate drive device includes a driven side of said clutch.

14. The hand-held fastener-driving tool as recited in claim 13, wherein when said nose sub-assembly is detached from said housing, said drive side of the clutch detaches from said driven side of the clutch, without damage to said clutch.

15. A hand-held fastener-driving tool, comprising:
(a) a housing containing a prime mover device, said housing having a first end and a second end, said housing including a first intermediate drive device that translates movement from said prime mover device toward said second end;
(b) a handle that is positioned proximal to said housing;
(c) a hand-operated control device, and when said control device is actuated, said prime mover device may be engaged;
(d) an attachable/detachable nose sub-assembly having a third end and a fourth end, wherein when said nose sub-assembly is mated to said housing, said third end is positioned proximal to said second end of the housing; wherein:
(i) said third end includes a second intermediate drive device that may be in communication with said first intermediate drive device when said housing is attached to said nose sub-assembly, and
(ii) said fourth end of the nose sub-assembly includes a fastener driving mechanism that is used for driving a fastener into an object, said fastener driving mechanism being in communication with said second intermediate drive device; and
(e) a quick release latching mechanism, wherein:
(i) when said housing and said nose sub-assembly are brought together, the quick release latching mechanism becomes engaged to hold said housing and said nose sub-assembly together, such that said first and second intermediate drive devices may operate in communication with one another, and such that said fastener driving mechanism may be driven by said prime mover device through said first and second intermediate drive devices; and
(ii) when disengaged, the quick release latching mechanism allows said nose sub-assembly to readily detach from said housing, wherein said first and second intermediate drive devices may separate without damage to one another.

16. The hand-held fastener-driving tool as recited in claim 15, wherein said prime mover device comprises one of: (a) an electric motor; (b) a pneumatic motor; (c) a pneumatic pump; (d) a hydraulic motor; and (e) a hydraulic pump.

17. The hand-held fastener-driving tool as recited in claim 16, wherein said electric motor is powered with electrical energy from one of: (a) a battery; and (b) a power cord.

18. The hand-held fastener-driving tool as recited in claim 15, wherein said latching mechanism comprises: (a) a spring-loaded lever having a catch on one end; (b) a hinge pin that is positioned though an opening in said lever, and which holds said lever to one of said housing and said nose sub-assembly; and (c) a ramp structure on one of said housing and said nose sub-assembly, said ramp structure having a latching edge; wherein:
(d) to attach said nose sub-assembly to said housing, said lever is slid over said ramp structure until reaching a position where said catch of the lever clears said latching edge of the ramp, and said lever pivots about said hinge pin such that said catch reaches a position against said latching edge of the ramp structure; and
(e) to detach said nose sub-assembly from said housing, said lever is pressed by a user such that the lever pivots about said hinge pin to remove said catch from making contact with said ramp structure.

19. The hand-held fastener-driving tool as recited in claim 15, further comprising: a user actuatable reversing trigger control.

20. The hand-held fastener-driving tool as recited in claim 15, further comprising: a user adjustable torque limiter control.

21. The hand-held fastener-driving tool as recited in claim 20, wherein said torque limiter control is located at one of: (a) proximal to said first end of the housing; and (b) on an upper surface of said housing, between said first and second ends.

22. The hand-held fastener-driving tool as recited in claim 15, wherein said nose sub-assembly comprises one of: (a) a sheet cutting attachment; and (b) an automatic feed fastener-driving attachment that operates with a collated strip of fasteners, and which includes a user-adjustable mechanical depth of drive control mounted on said nose sub-assembly; (c) an automatic feed fastener-driving attachment that operates with said collated strip of fasteners, and which includes a user-adjustable torque limiter control mounted on said housing; (d) a single feed fastener-driving attachment which includes a user-adjustable mechanical depth of drive control mounted on said nose sub-assembly, in which a user holds an individual fastener at said fourth end of the nose sub-assembly to be driven by said fastener driving mechanism; and (e) a single feed fastener-driving attachment which includes a user-adjustable torque limiter control mounted on said housing, in which a user holds an individual fastener at said fourth end of the nose sub-assembly to be driven by said fastener driving mechanism.

23. The hand-held fastener-driving tool as recited in claim 15, wherein said tool is used in at least one of the following modes of operation: (a) said nose sub-assembly is detached from said housing to expose a drive bit, and a user drives a single fastener into said object by manually holding that fastener; (b) said nose sub-assembly is detached from said housing to expose a drive bit, and a user removes a fastener that had previously been driven into said object; (c) said nose sub-assembly is attached to said housing such that a collated strip of fasteners can automatically be driven into said object; and (d) said nose sub-assembly is attached to said housing such that a single fastener can be driven into said object, as a user holds said single fastener at said fourth end of the nose sub-assembly.

24. The hand-held fastener-driving tool as recited in claim 15, further comprising a guide rail structure, a first portion of said guide rail structure being located on said housing, and a second portion of said guide rail structure being located on said nose sub-assembly, such that a collated strip of fasteners is fed into said first portion of the guide rail structure and travels therethrough, then said collated strip of fasteners travels into said second portion of the guide rail structure and travels therethrough, finally arriving at said fastener driving mechanism; wherein said first and second portions of the guide rail structure may be readily separated without damage thereto, when said nose sub-assembly is detached from said housing.

25. The hand-held fastener-driving tool as recited in claim 15, wherein said nose sub-assembly operates in one of the following modes: (a) index on advance; and (b) index on return.

26. The hand-held fastener-driving tool as recited in claim 15, wherein said nose sub-assembly includes (a) a movable front-most nose piece at said fourth end, and (b) a movable slide body sub-assembly, for use with a collated strip of fasteners.

27. The hand-held fastener-driving tool as recited in claim 15, wherein said handle is positioned substantially at one of (a) said first end of said housing; and (b) a mid-position that is between said first and second ends of the housing.

28. The hand-held fastener-driving tool as recited in claim 15, further comprising a clutch between said first and second intermediate drive devices, wherein: (a) said first intermediate drive device includes a drive side of said clutch; and (b) said second intermediate drive device includes a driven side of said clutch.

29. The hand-held fastener-driving tool as recited in claim 28, wherein when said nose sub-assembly is detached from said housing, said drive side of the clutch detaches from said driven side of the clutch, without damage to said clutch.
